(19) United States
(12) Patent Application Publication
(10) Pub. No.: US 2011/0010273 A1
(43) Pub. Date: Jan. 13, 2011

(54) Method and System for Conducting Product Competition

(76) Inventor: Jeong Gab Lee, Seoul (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/787,965

(22) Filed: May 26, 2010

(30) Foreign Application Priority Data
Jul. 7, 2009 (KR) 10-2009-0061844

(51) Int. Cl. G06Q 30/00

(52) U.S. Cl. 705/27.2

(57) ABSTRACT

Provided is a method of conducting a product competition using a product competition conducting system including a popularity rank determiner, a competition product extractor, a competition space provider, a competition rank determiner, and a benefit giver. The method includes: determining popularity ranks of a plurality of products using the popularity rank determiner, extracting some of the plurality of products according to the determined popularity rank using the competition product extractor; providing a competition space such that a competition between the extracted products is conducted using the competition space provider; when the competition between the extracted products is conducted in the provided competition space and a predetermined time has lapsed, determining competition ranks using the competition rank determiner; and giving benefits corresponding to the determined competition rank using the benefit giver.

### CROSS-REFERENCE TO RELATED APPLICATION

This application claims the benefit under 35 U.S.C. §119(a) of Korean Patent Application No. 10-2009-61844, filed on Jul. 7, 2009, which is hereby incorporated by reference in its entirety.

### FIELD OF THE INVENTION

The present invention relates to a method and system for conducting a competition between products.

### DESCRIPTION OF THE RELATED ART

Interest in the Internet has recently been increasing explosively. As such, the Internet has been being developed as a commercial activity stage aiming at seeking profit rather than acting as an auxiliary means of simple communication. Further, with the development of communication and electronic commerce based on the Internet, Internet shopping malls are rapidly developing.

### BRIEF SUMMARY

The present invention is directed to a method and system of conducting a product competition between a plurality of product distributors selling the same product.

The present invention is also directed to a method and system of conducting a product competition, capable of displaying detailed information about a specific product and a competition situation of at least one comparative product through a specific server in real time.

According to an aspect of the present invention, there is provided a method of conducting a product competition using a product competition conducting system including a popularity rank determiner, a competition product extractor, a competition space provider, a competition rank determiner, and a benefit giver, the method including determining, by the popularity rank determiner, popularity ranks of a plurality of products, extracting, by the competition product extractor, some of the plurality of products according to the determined popularity rank; providing, by the competition space provider, a competition space such that a competition between the extracted products is conducted; when the competition between the extracted products is conducted in the provided competition space and a predetermined time has lapsed, determining, by the competition rank determiner, competition ranks; and giving, by the benefit giver, benefits corresponding to the determined competition rank.

According to another aspect of the present invention, there is provided a method of conducting a product competition using a product competition conducting system including an input unit and a control unit having a product distributor extractor, a competition space provider, a competition rank determiner, and a benefit giver, the method including: receiving, by the input unit, an input of a specific keyword; extracting, by the product distributor extractor, at least two product distributors selling a specific product corresponding to the specific keyword; providing, by the competition space provider, a competition space such that a competition between the extracted at least two product distributors is conducted; when a competition structure between the at least two product distributors is established in the provided competition space, determining, by the competition rank determiner, competition ranks in consideration of at least one selected from sales and a number of product links of the specific product of each product distributor; and giving, by the benefit giver, benefits corresponding to the determined competition rank.

According to still another aspect of the present invention, there is provided a method of conducting a product competition using a product competition conducting system providing a specific server having an input unit, a control unit, and a display unit, the method including: receiving, by the input unit, an input of a selection signal for a specific product; controlling, by the control unit, the display unit to output sale information about the selected specific product and link information about at least one shopping mall selling the specific product to the specific server; when the input unit receives the selection signal for the link information about the specific shopping mall among the link information about the at least one shopping mall, controlling, by the control unit, the display unit to output a screen for the specific shopping mall to the specific server, the screen including information about the specific product and information about a comparative product associated with the specific product; providing, by the control unit, a competition space through the screen for the specific shopping mall such that a competition between the specific product and the comparative product is conducted at the specific server; when a competition structure between the specific product and the comparative product is established at the specific server, determining, by the control unit, competition ranks in consideration of sales records of the specific product and the comparative product for a predetermined time; and giving, by the control unit, benefits corresponding to the competition rank on a buyer who buys one of the specific product and the comparative product at the specific server.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a schematic block diagram showing the configuration of a system for conducting a product competition according to an exemplary embodiment of the present invention;

FIG. 2 is a schematic block diagram showing the configuration of a control unit in a product competition conducting system that conducts a product competition on the basis of a popular search rank in accordance with an exemplary embodiment of the present invention;

FIG. 3 is a schematic flowchart showing a method of conducting a product competition according to a popular search rank in accordance with an exemplary embodiment of the present invention;

FIG. 4 is a schematic block diagram showing the configuration of a control unit in a product competition conducting system that conducts a competition between distributors where the same product is sold in accordance with an exemplary embodiment of the present invention;

FIG. 5 is a schematic flowchart showing the operation of a method of conducting a product competition between product distributors selling the same product in accordance with an exemplary embodiment of the present invention;

FIG. 6 is a schematic flowchart showing a product competition conducting method carried out through a specific server in accordance with an exemplary embodiment of the present invention;

FIG. 7 is a view for explaining a method of conducting a multilateral product competition according to a popular search rank in accordance with an exemplary embodiment of the present invention;

FIG. 8 is a view for explaining a method of conducting a product competition between shopping malls selling the same product in accordance with an exemplary embodiment of the present invention;

FIG. 9 is a view showing a table for comparing characteristics based on a product competition type in accordance with an exemplary embodiment of the present invention;

FIG. 10 is a view showing a method of conducting a product competition between shopping malls selling the same product in accordance with an exemplary embodiment of the present invention;

FIG. 11 is a view for explaining a method of moving to a competition space linked when a specific product is selected at a portal site (or in an advertisement space) in accordance with an exemplary embodiment of the present invention;

FIG. 12 is a view for explaining a product competition conducting method of displaying a competition situation of comparative products in real time in accordance with an exemplary embodiment of the present invention; and

FIG. 13 is a view for explaining a product competition conducting method carried out regardless of a search in accordance with an exemplary embodiment of the present invention.

### DETAILED DESCRIPTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided to fully enable those of ordinary skill in the art to embody and practice the invention. The configuration and action of the present invention shown in the drawings and described with reference to the drawings will be described as at least one embodiment; however, the technical idea and the core configuration and action of the present invention are not limited thereto.

The terms used in the present invention are defined in accordance with the functions made in the present invention, which may be varied according to the intention or practices of those people who work in the arts, and therefore, it should be understood that they do not limit the technical components of the present invention.

Although the terms used herein are selected from general terms used as widely as possible up to now in consideration of functions of components of the present invention, they may vary according to the intentions or practices of those technicians who work in the arts, the advent of new technology, and so on. Further, some of the terms mentioned in the description of the present invention have been selected by the applicant at his or her discretion, the detailed meanings of which are described in relevant parts of the description of the present invention. Therefore, it will be understood that the terms used herein should be defined on the basis of their comprehensive meanings and the contents throughout the specification of the present invention rather than their simple meanings.

The term “shopping mall,” as used throughout the specification, refers to a shopping center exhibiting products for sale without real distributors or stores. The shopping mall may be realized in the cyberspace of a computer communication network. For example, the shopping mall may be realized for wired/wireless Internet shopping, Internet protocol television (IPTV) shopping, television (TV) home shopping, and so on.

The term “product competition,” as used throughout the specification, refers to a competition between a plurality of products. The product competition may include a competition between predetermined products according to an order of popularity. Further, the product competition may include a competition between a plurality of distributors, each of which sells the same product on different terms of sale. In addition, the product competition may include a competition between a specific product and a comparative product, which is searched through comparison with the specific product. The product competition may be telecast through a specific medium in real time. Here, the specific medium may include a cable or terrestrial TV, IPTV, Internet user created content (UCC), a server of the press, or the like.

The term “competition structure,” as used throughout the specification, refers to a category structure that is established between a plurality of products to compete with a specific product. The competition structure may be classified into a 1:1 competition structure, a multilateral competition structure, and so on. Further, the competition structure may be expanded to a survival system or a tournament system. Here, in the survival system, a competition may be determined by a knockout win, a win on points, and a tie. In the tournament system, the competition may be determined according to a point, a winning rate, and so on. For example, the knockout win may be applied when the products are sold out. The win on points may be determined on the basis of a total amount of orders or sales for specific products. The expanded competition system may further include detailed systems such as a double elimination system and a return match. Meanwhile, the product competition structure may be established by a seller, a buyer, a recommender, and a competition planner of the specific product. The product competition structure may be established on the basis of a kind, brand name, product name, etc. of the specific product. Further, when the competition structure is established, the product competition system according to the present invention may further cast a vote for or against the established competition structure. The product competition system may determine whether or not to proceed with the competition of the corresponding product with reference to the result of the vote.

The term “benefits,” as used throughout the specification, refers to a separate bonus paid in proportion to a competition rank determined according to a result of conducting the product competition. The benefits may be given to a seller who sells the product and a buyer who buys the product. The benefits may include the accumulation of points, the provision of a discount coupon, the accumulation of mileage, the presentation of a free gift, the payment of game money, and so on. The benefits may be differentially given in proportion to the competition rank. For example, the seller having a superior competition rank may be given the benefits such as a discount of a commission on a sale of the product and a priority of advertisement. In contrast, the seller having an inferior competition rank may be given a penalty such as prohibition of a sale in a predetermined period, or a relatively high commission rate. Further, an accumulation rate of the accumulated money of the buyer, a discount rate of the commission of the seller, etc. may be differentially applied in proportional to the competition rank.

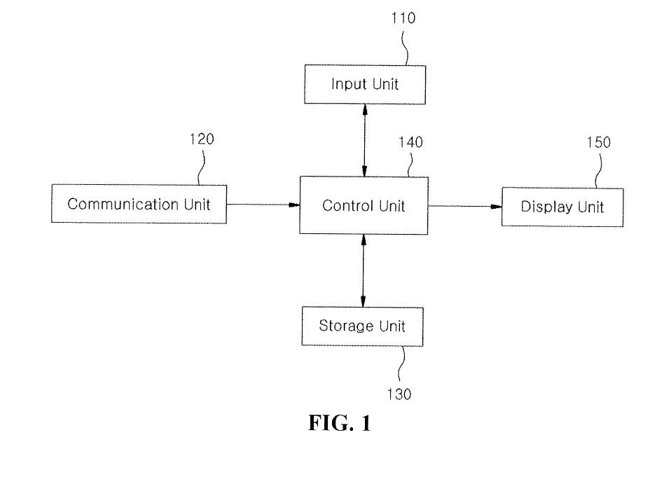

FIG. 1 is a schematic block diagram showing the configuration of a system for conducting a product competition according to an exemplary embodiment of the present invention.

As shown in FIG. 1, the product competition conducting system according to an exemplary embodiment of the present invention may include an input unit 110, a communication unit 120, a storage unit 130, a control unit 140, and a display unit 150.

The input unit 110 may receive various signals input from the outside. The input unit 110 may receive specific data (e.g. a specific keyword) input from the outside. For example, the input unit 110 may receive a selection input of a specific product. Further, the input unit 110 may receive an input of a specific keyword. Here, the keyword may include a keyword indicating a specific product.

The communication unit 120 may support communication between the product competition conducting system, a seller, and a buyer. Further, the communication unit 120 may be automatically connected to a specific medium advertising the result of conducting the competition after the product competition is completed. The specific medium may include a cable or terrestrial TV, IPTV, Internet user created content (UCC), a server of the press, or the like.

The storage unit 130 may store the competition result updated under control of the control unit 140. That is to say, the storage unit 130 may store items for competition history management according to each seller. The competition history management may be classified into categories according to the competition result, brand, product, and date. Further, the competition history management may further include a result of conducting a competition on the product for sale and a bonus payment situation. Thus, the product competition conducting system may assign priority ranks to the sellers on the basis of the competition history. For example, using the competition history management, the rank may be decided for a multi-win champion, a knockout champion, a winning rate champion, and so on, and then the benefits such as an order of advertisement, an order of publicity, a commission discount, etc. may be preferentially given according to the decided rank.

The control unit 140 may receive a request for the product competition. The control unit 140 may establish the product competition structure to conduct the product competition on the basis of the received request for the product competition. When a predetermined time has lapsed, the control unit 140 may analyze a result of conducting the product competition. Here, the result of conducting the product competition may be determined according to sales records. The sales records may include a total amount of orders or sales for the products. Then, the controller 140 may select a winning seller on the basis of the analyzed result of the product competition. The control unit 140 may give a predetermined winning bonus to the selected winning seller. Further, the control unit 140 may control the display unit 150 to display the situation of the product competition in real time.

The display unit 150 may display the situation of the product competition in real time under control of the control unit 140. Further, the display unit 150 may display various pieces of information and advertisements under control of the control unit 140.

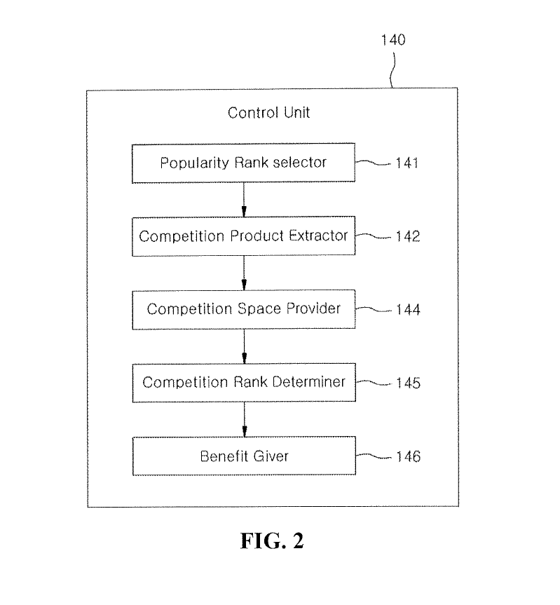

FIG. 2 is a schematic block diagram showing the configuration of a control unit in a product competition conducting system that conducts a product competition on the basis of a popular search rank in accordance with an exemplary embodiment of the present invention. Here, the product competition conducting system shown in FIG. 2 may have the same configuration as that shown in FIG. 1. As such, in describing the product competition conducting system shown in FIG. 2, some components (e.g. a communication unit, a storage unit, and a display unit) of the product competition conducting system shown in FIG. 2 will not be described. The product competition conducting system may be realized by a portal site operation server capable of providing a portal site.

As shown in FIG. 2, the product competition conducting system according to an exemplary embodiment of the present invention may conduct the product competition on the basis of a popular search rank. The control unit 140 for realizing the product competition conducting system may include a popularity rank selector 141, a competition product extractor 142, a competition space provider 144, a competition rank determiner 145, and a benefit giver 146.

The popularity rank selector 141 may select popularity ranks of a plurality of products. That is to say, the popularity rank selector 141 may select the popularity rank on the basis of the number of specific keyword inputs, the number of product searches, the number of clicks, a selling rate, and a customer rating, all of which are input through the input unit 110 for a predetermined time. For example, the popularity rank selector 141 may count the number of times a keyword is input through a keyword input window of a specific site (e.g. a portal site) or the number of searches, and select the popularity rank corresponding to the keyword. The popularity rank selector 141 may select the popularity rank according to the number of clicks for a link when the advertisement for the specific product appearing in the specific site is selected. Further, the popularity rank selector 141 may select the popularity rank with further reference to a result of separately casting a popularity vote. Here, the result of casting a popularity vote may include those directly done at a corresponding shopping mall and those provided from the outside (e.g. another affiliated external provider, channel, and site).

The competition product extractor 142 may extract a predetermined number of products from the plurality of products corresponding to the keyword according to the popularity rank selected by the popularity rank selector 141. In other words, the competition product extractor 142 may sequentially extract a predetermined number of products from the plurality of products corresponding to the keyword starting with the product having a high popularity rank. Here, the competition product extractor 142 may extract at least two products.

The competition space provider 144 may provide a competition space such that the products extracted by the competition product extractor 142 compete with each other. The competition space provider 144 may provide the competition space such that at least two products compete with each other. In detail, the competition space provided by the competition space provider 144 may include a 1:1 competition space for the competition between two products or a multilateral competition space for the competition between two or more products. Here, a subject of the competition may be the extracted product itself.

The competition rank determiner 145 may determine competition ranks of the plurality of products, between which the competition is conducted. In detail, when the competition structure between the plurality of products is established in the competition space provided by the competition space provider 144, the product competition may be conducted. Then, when a predetermined time has lapsed, the competition rank determiner 145 may determine the competition ranks of the products, between which the competition is conducted. At this time, the competition rank determiner 145 may determine the competition rank on the basis of sales records corresponding to each product. That is to say, when the competition between at least two products is established in the competition space, the competition rank determiner 145 may determine the competition ranks in consideration of sales records such as sales of the products. Further, the competition rank determiner 145 may provide a situation of the ongoing product competition to a specific member in real time. The specific member may include a charged member. The charged member may include a person who pays an annual membership fee or buys game money (i.e. competition money). For example, in the case where the specific member buys the game money, the specific member may be provided with charged member service during the possession of the game money.

The benefit giver 146 may give benefits corresponding to the determined competition rank of the product. The benefit giver 146 may give the benefits on a seller who sells the product or a buyer who buys the product. Here, the benefit giver 146 may differentially give the benefits according to the competition rank determined by the competition rank determiner 145. Further, the benefit giver 146 may give the benefits on a vote participant when the vote participant selecting a specific product through a popularity vote buys the specific product. The benefits given by the benefit giver 146 may include the accumulation of points, the provision of a discount coupon, the accumulation of mileage, the presentation of a free gift, the payment of game money, and so on.

Meanwhile, when the competition structure is established, the competition rank determiner 145 may determine the competition rank in consideration of the number of clicks for a link from an advertisement space where one of the at least two products is advertised to the competition space, and the number of clicks for a link from the competition space to the advertisement space. For example, the competition space may be a specific server conducting the product competition, and the advertisement space may be a specific server in which the advertisement for the product is inserted. The link from the competition space to the advertisement space may be defined as a forward link, while the link from the advertisement space to the competition space may be defined as a backward link. Here, an applied weight may vary according to the click for the forward or backward link. As such, the benefit giver 146 may give the benefits corresponding to the competition rank on a subject who carries out the click. In detail, the benefit giver 146 may give the benefits on the subject (e.g. a buyer, a netizen, etc.) who carries out the click for the forward or backward link so as to be suitable for the subject.

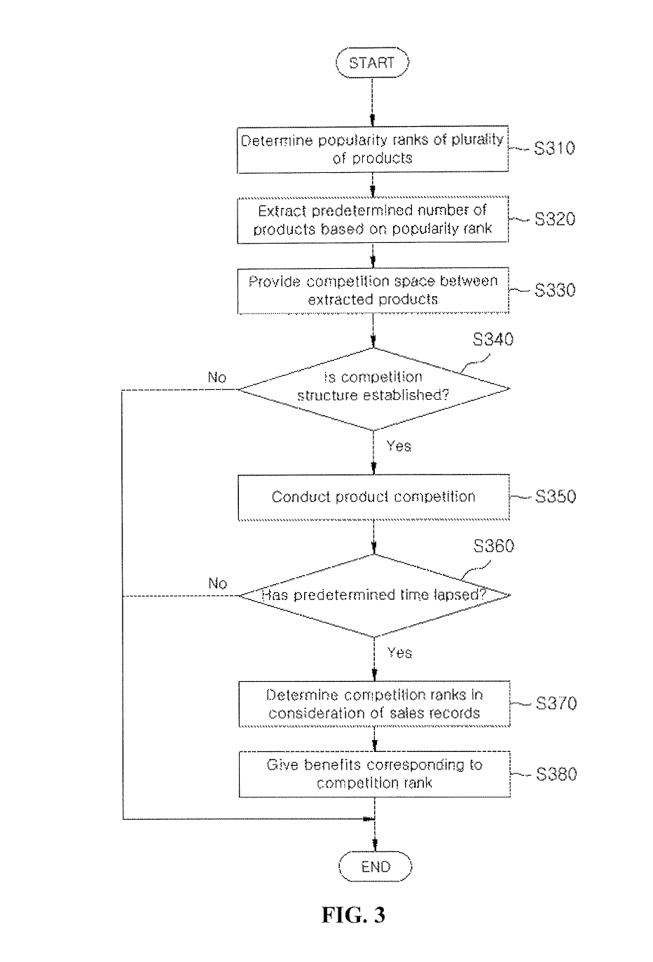

FIG. 3 is a schematic flowchart showing a method of conducting a product competition according to a popular search rank in accordance with an exemplary embodiment of the present invention.

As shown in FIG. 3, the product competition conducting method may be realized so as to select popular search ranks of a plurality of products, extract a predetermined number of products according to the selected popular search rank, establish a competition structure between the extracted products, and conduct a product competition.

First, the popularity rank selector 141 may select popularity ranks of a plurality of products (S310). The popularity rank may be selected on the basis of the number of specific keyword inputs, the number of product searches, the number of clicks, a selling rate, and a customer rating. The popularity rank selector 141 may select the popularity rank including a popular search rank and a popular selection rank. The popular search rank may be selected on the basis of the number of times a keyword is input through a keyword input window of a specific site (e.g. a portal site) and the number of searches in order to search for a specific product. The popular selection rank may be selected on the basis of the number of times a specific product advertised in an advertisement space is selected (or clicked). In detail, the popularity rank selector 141 may select the popularity rank on the basis of the number of inputs, the number of clicks, and the number of searches a specific keyword undergoes at the specific site for a predetermined time. Further, the popularity rank selector 141 may select the popularity rank with further reference to the result of separately casting a popularity vote. Here, the result of casting a popularity vote may include those directly done at a corresponding shopping mall and those provided from the outside (e.g. another affiliated external provider, channel, and site).

Afterwards, the competition product extractor 142 may extract a predetermined number of products from the plurality of products corresponding to the keyword according to the popularity rank selected by the popularity rank selector 141 (S320). Here, the competition product extractor 142 may sequentially extract a predetermined number of products from the plurality of products starting with the product having a high popularity rank. Here, the competition product extractor 142 may extract at least two products.

Then, when the competition space provider 144 provides a competition space, a competition structure between the extracted products may be established in the provided competition space, and thus the competition between the products may be conducted (S330, S340, and S350). In detail, the competition space may be provided by the competition space provider 144. Then, the competition structure between the products extracted by the competition product extractor 142 may be established in the provided competition space, and thus the competition between the products may be conducted. Meanwhile, when the competition structure is established in the competition space, the competition rank determiner 145 may determine a competition rank in consideration of either the number of clicks for a link (i.e. a forward link) from the advertisement space where a certain product is advertised to the competition space or the number of clicks for a link (i.e. a backward link) from the competition space to the advertisement space.

Afterward, the benefit giver 146 may give benefits corresponding to the determined competition rank (S380). The benefit giver 146 may give the benefits on a seller who sells the product or a buyer who buys the product. Here, the benefit giver 146 may differentially give the benefits corresponding to the competition rank determined by the competition rank determiner 145. Further, the product competition may be connected with a separate popularity vote. Thus, when a vote participant selecting a specific product through the connected popularity vote buys the specific product, the benefit giver 146 may give the benefits on the vote participant. In addition, the benefit giver 146 may give the benefits corresponding to the competition rank on a subject who carries out the click. In detail, the benefit giver 146 may give the benefits on the subject (e.g. a buyer, a netizen, etc.) who carries out the click for the forward and backward links so as to be suitable for the subject. The benefits given by the benefit giver 146 may include the accumulation of points, the provision of a discount coupon, the accumulation of mileage, the presentation of a free gift, the payment of game money, and so on.

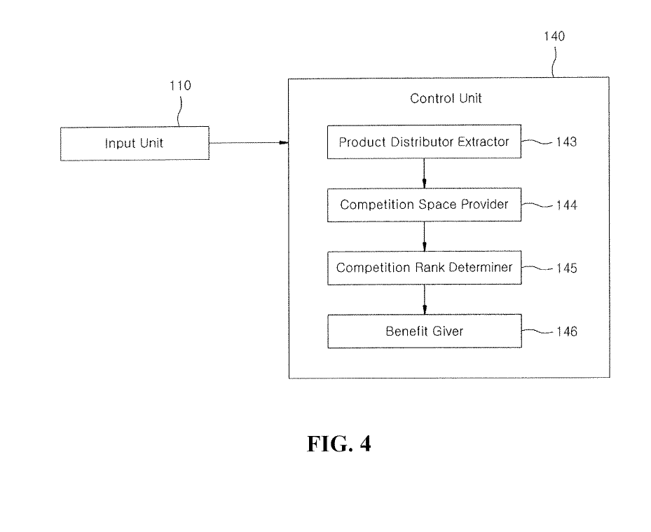

FIG. 4 is a schematic block diagram showing the configuration of a control unit in a product competition conducting system that conducts a competition between distributors where the same product is sold in accordance with an exemplary embodiment of the present invention.

As shown in FIG. 4, the product competition conducting system according to an exemplary embodiment of the present invention may realize a product competition between product distributors where the same product is sold on different terms of sale. The product competition conducting system may include an input unit 110 and a control unit 140.

The input unit 110 may receive the selection input of a specific product. Further, the input unit 110 may receive the input of a specific keyword. Here, the keyword may include a keyword indicating the specific product. When the keyword is input, a product distributor extractor 143 may search for products corresponding to the input keyword, and extract product distributors of the searched products. At this time, the input unit 110 may further receive a search condition input for searching for the specific product among the products corresponding to the keyword. The keyword, information about the products corresponding to the keyword, information about the product distributors, etc. may be stored in the storage unit 130.

The control unit 140 may include a product distributor extractor 143, a competition space provider 144, a competition rank determiner 145, and a benefit giver 146.

The product distributor extractor 143 may extract product distributors (e.g. an Internet shopping mall, etc.) that sell products corresponding to the keyword. The product distributors may be at least two sellers or shopping malls that sell the same product. Here, the at least two product distributors may sell the same product on different terms of sale. For example, first, second, and third shopping malls may sell a product A. In this case, the first shopping mall may sell the product A on the terms of sale that give benefits of three month installments without interest. The second shopping mall may sell the product A on the terms of sale that give benefits of free shipping and three month installments without interest. The third shopping mall may sell the product A on the terms of sale that give benefits of free shipping and discount coupon representation. Thus, a buyer who wants to buy the product A may decide a purchase advantageous to himself/herself by comparing the terms of sale of the first, second and third shopping malls with one another.

The competition space provider 144 may provide a competition space such that the product competition between the at least two extracted product distributors can be conducted. In detail, the competition space provider 144 may provide the competition space for the product competition conducted between the at least two product distributors selling the same product. Here, a subject of the competition may be the product distributor itself. For example, the competition space provided by the competition space provider 144 may include a 1:1 competition space or a multilateral competition space for the competition between a plurality of product distributors. Here, each product distributor may provide different terms of sale for selling the same product.

The competition rank determiner 145 may determine competition ranks for the product competition between at least two product distributors. In detail, a competition structure between at least two product distributors (i.e. a plurality of product distributors) may be established for the same product in the competition space provided by the competition space provider 144. Then, the product competition can be conducted with the established competition structure (i.e. the competition between the plurality of product distributors providing different terms of sale with respect to the same product). Afterward, when a predetermined time has lapsed, the competition rank determiner 145 may determine the competition ranks of the plurality of product distributors. At this time, the competition rank determiner 145 may determine the competition rank on the basis of sales records of each corresponding product. Meanwhile, the competition rank determiner 145 may determine the competition ranks in further consideration of the number of clicks for a link from the competition space to any one of the product distributors. Here, the competition space may be a server that conducts the competition between the product distributors. The product distributor may include a shopping mall that is managed through a specific server. Further, the competition rank determiner 145 may provide a situation of the ongoing product competition to a specific member in real time. The specific member may include a charged member. The charged member may include a person who pays an annual membership fee or buys game money (i.e. competition money).

The benefit giver 146 may give benefits corresponding to the determined competition rank. For example, in the case where the product distributor is an Internet shopping mall, the benefit giver 146 may give benefits of an affiliated fee discount of the Internet shopping mall so as to correspond to the determined competition rank. Further, the benefit giver 146 may give the benefits on a buyer who buys the corresponding product from the product distributor according to the determined competition rank. Here, the benefits given by the benefit giver 146 may include the accumulation of points, the accumulation of mileage, the provision of a discount coupon, the payment of game money, the presentation of a free gift, the lottery of a premium, and so on. The benefit giver 146 may differentially give the benefits corresponding to the determined competition rank.

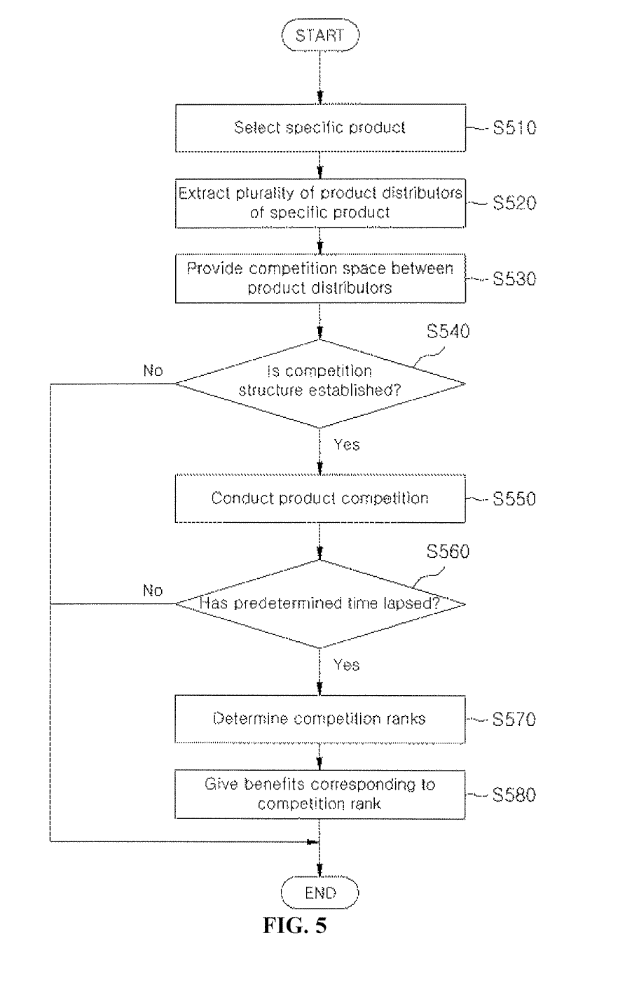

FIG. 5 is a schematic flowchart showing the operation of a method of conducting a product competition between product distributors selling the same product in accordance with an exemplary embodiment of the present invention.

As shown in FIG. 5, the product competition conducting method according to an exemplary embodiment of the present invention may be carried out between a plurality of product distributors, each of which sells the same product on different terms of sale. Further, the product competition conducting system according to an exemplary embodiment of the present invention may provide a competition space to a portal site. Thus, when a specific product is selected from a plurality of products while a competition between the plurality of products is being conducted at the portal site to which the competition space is provided, the portal site may be linked to a product distributor site of the specific product. At this time, the product distributor site linked from the portal site may be set to pay a predetermined fee to the portal site. Thus, the control unit 140 may control the product competition to be conducted within the specific server into which a keyword is input without being linked to another server.

First, when a specific product is selected, a plurality of product distributors selling the specific product may be extracted, and thus a competition space for conducting a competition between the extracted product distributors may be provided (S510, S520, and S530). In other words, the specific product may be searched through a keyword input window of a specific site (e.g. a portal site, etc.). Here, a search condition for searching for the specific product may be further input. The search condition may include a kind, brand name, product name, etc. of a product to be searched. Further, a specific product advertised through an advertisement space of the specific site may be selected. Then, the product distributor extractor 143 may extract a plurality of product distributors selling the specific product. Here, the plurality of product distributors may sell the same product on different terms of sale. In detail, each product distributor may sell the specific product on the terms of sale of a distribution fee, the number of months of interest-free installments, a discount coupon, and so on. Afterward, the competition space provider 144 may provide the competition space such that the competition between the plurality of product distributors extracted by the product distributor extractor 143 can be conducted.

A competition structure between the product distributors may be established in the provided competition space, and thus the competition may be conducted (S540 and S550). The competition structure may include a 1:1 competition structure or a multilateral competition structure. A subject of the established competition structure may be the product distributor itself.

Afterward, when a predetermined time has lapsed, competition ranks may be determined (S560 and S570). Here, the competition rank determiner 145 may determine the competition rank on the basis of sales records of the same product of each product distributor. Further, when the competition structure between the product distributors is established in the competition space, the competition rank determiner 145 may determine the competition ranks in consideration of either the number of clicks for a link (i.e. a forward link) from an advertisement space where the plurality of products are advertised to a specific product distributor or the number of clicks for a link (i.e. a backward link) from the specific product distributor to the advertisement space.

Then, the benefit giver 146 may give benefits corresponding to the determined competition rank (S580). The benefit giver 146 may give the benefits to the product distributor or a buyer who buys the product sold at the product distributor. Here, the benefit giver 146 may differentially give the benefits according to the competition rank determined by the competition rank determiner 145. The benefits may include the accumulation of points, the accumulation of mileage, the provision of a discount coupon, the presentation of a free gift, the payment of game money, and so on.

As described above, the product competition conducting method according to an exemplary embodiment of the present invention includes conducting the competition between the product distributors selling the same product on different terms of sale, so that the buyer can more easily decide on a purchase with reference to the terms of sale provided by each product distributor.

Further, the product competition conducting method according to an exemplary embodiment of the present invention realizes the product competition conducting system (i.e. the competition space) in the advertisement space (e.g. the specific portal site) advertising the specific product, so that the product competition can be easily conducted without being linked to the product distributor (e.g. the specific shopping mall) of the specific product.

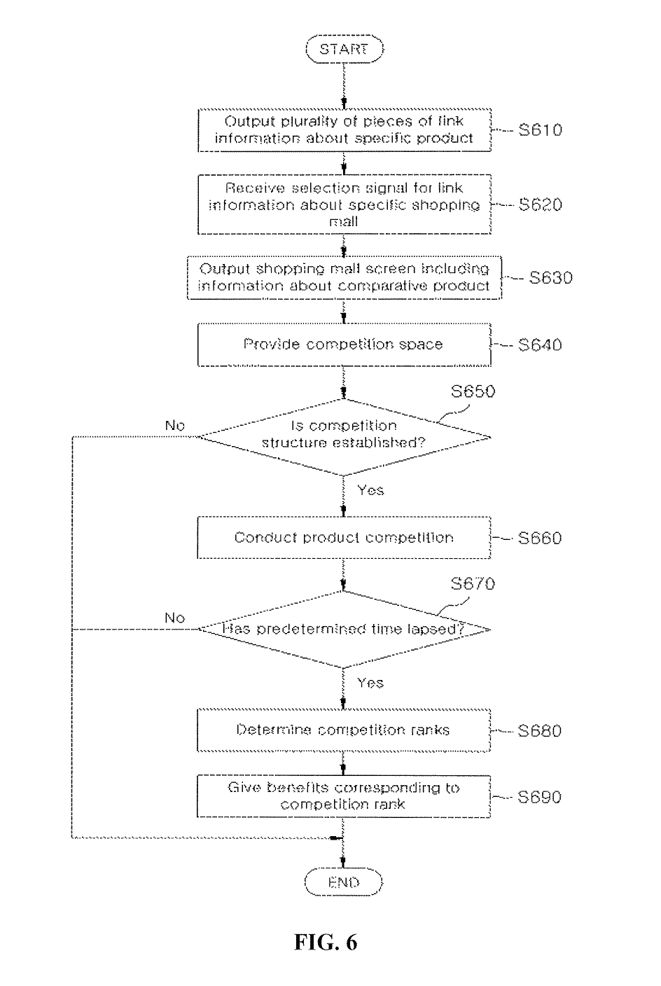

FIG. 6 is a schematic flowchart showing a product competition conducting method carried out through a specific server in accordance with an exemplary embodiment of the present invention.

The product competition conducting method carried out through a specific server as shown in FIG. 6 may be realized by the product competition conducting system as shown in FIG. 1. Thus, first, the product competition conducting system for realizing the product competition conducting method carried out through the specific server will be described with reference to FIG. 1. Hereinafter, in describing the product competition conducting system for realizing the product competition conducting method carried out through the specific server, some components (e.g. the communication unit, the storage unit, etc.) of the product competition conducting system shown in FIG. 1 will not be described.

As shown in FIG. 1, the product competition conducting system for realizing the product competition conducting method carried out through the specific server in accordance with an exemplary embodiment of the present invention may include an input unit 110, a control unit 140, and a display unit 150.

The input unit 110 may receive various selection signals input from the outside. For example, a plurality of pieces of link information about a shopping mall may be output to a specific server. Then, the input unit 110 may receive the selection signal for one among the plurality of pieces of link information about the shopping mall that is input to select a specific shopping mall.

The control unit 140 may control information about the sale of a specific product and the link information about at least one shopping mall selling the specific product to be output to the specific server. When the selection signal for the link information about the specific shopping mall among the output link information about at least one shopping mall is received, the control unit 140 may control a screen for the specific shopping mall to be output to the specific server, in which the screen includes information about the specific product and information about at least one comparative product associated with the specific product. Here, the control unit 140 may control information associated with the comparative product to be output to a predetermined region of the shopping mall screen. The information associated with the comparative product may include a competition situation of the comparative product. Only when a buyer consents to see the comparative product, may the control unit 140 control the display unit 150 to display the competition situation of the comparative product in real time. The control unit 140 may control various pieces of information associated with the specific product to be output. Further, when a keyword is input through the input unit 110, the plurality of shopping malls may include all shopping malls associated with products corresponding to the keyword. The control unit 140 may control the information associated with the specific product to be updated and output in real time. The comparative product may be extracted by the control unit 140, in consideration of the number of clicks, sales records, a popularity vote result, etc. of the product. Further, the comparative product may be a product sold at the specific shopping mall or at another shopping mall. In addition, the control unit 140 may provide a competition space through the screen for the specific shopping mall such that a competition between the specific product and the comparative product is conducted at the specific server. When the competition between the specific product and the comparative product is conducted, the control unit 140 may determine competition ranks in consideration of the sales records of the specific product and the comparative product for a predetermined time. Then, the control unit 140 may give benefits corresponding to the determined competition rank. The benefits may be given to a seller who sells the specific product or a buyer who buys the specific product. The benefits may be differentially given according to the competition rank determined by the control unit 140. The benefits may include the accumulation of points, the accumulation of mileage, the provision of a discount coupon, the presentation of a free gift, the payment of game money, and so on. Further, the control unit 140 may provide a situation of the ongoing product competition to a specific member. The specific member may include a charged member.

The display unit 150 may display the information about the sale of the specific product and the link information about at least one shopping mall selling the specific product output to the specific server under the control of the control unit 140. Further, the display unit 150 may display the screen for the specific shopping mall to the specific server under the control of the control unit 140, in which the screen includes information about the specific product and information about a comparative product associated with the specific product.

Hereinafter, the product competition conducting method carried out through a specific server in accordance with an exemplary embodiment of the present invention as shown in FIG. 6 will be described. As shown in FIG. 6, the product competition conducting method according to an exemplary embodiment of the present invention may be configured so that a competition situation of at least one comparative product associated with the specific product can be displayed at the specific shopping mall selling the specific product in real time in addition to the detailed information about the specific product.

First, the control unit 140 may output a plurality of pieces of link information about a specific product to the specific server through the display unit 150 (S610). For example, the specific server providing a portal site may be searched for the specific product. Here, the specific server may be searched for the specific product by comparison. The search for the specific product by comparison may be carried out when a specific keyword is input through a keyword input window of the portal site or when the specific product advertised through a specific advertisement region is selected. Then, the control unit 140 may control various pieces of information associated with the specific product to be output. Here, the information associated with the specific product may include link information about a specific shopping mall selling the specific product. That is to say, the control unit 140 may control link information about a plurality of shopping malls selling the specific product to be output. Here, the plurality of shopping malls may include shopping malls that present different terms of sale of the same product and sell the specific product. Further, the plurality of shopping malls may include all the shopping malls associated with the products corresponding to the keyword.

When a selection signal for the link information about the specific shopping mall among the plurality of pieces of output link information is received through the input unit 110, the control unit 140 may output a screen for the shopping mall in which information about at least one comparative product is included (S620 and S630). In detail, when a buyer selects a specific shopping mall from the output shopping malls, the control unit 140 may control the screen for the selected shopping mall to be output through a screen of the specific server (i.e. the portal site). The screen for the shopping mall may display detailed information about the specific product. The detailed information may include purchase information such as description, discount information, installment information, mileage or point accumulation information, and so on. Here, the control unit 140 may control information associated with the comparative product to be further output to a predetermined region of the screen for the shopping mall. The information associated with the comparative product may include a product competition situation of the comparative product. The control unit 140 may control the information associated with the comparative product to be updated and output in real time. The comparative product may be extracted by the control unit 140, in consideration of the number of clicks, sales records, a popularity vote result, etc. of the product. Further, the comparative product may be a product sold at the specific shopping mall or at another shopping mall. Only when a buyer consents to see the comparative product, may the control unit 140 control the display unit 150 to display the competition situation of the comparative product in real time.

Then, when the control unit 140 provides a competition space to the specific server, a competition structure may be established in the provided competition space, and thus the product competition may be conducted (S640, S650 and S660). The control unit 140 may provide the competition space such that a competition between the specific product and the comparative product is conducted. The control unit 140 may provide the competition space to the specific server. The competition space may include a competition space for conducting a 1:1 competition or a multilateral competition.

Afterwards, when a predetermined time has lapsed, the control unit 140 may determine competition ranks of the conducted product competition, and give benefits corresponding to the determined competition rank (S670, S680 and S690). That is to say, the control unit 140 may determine the competition ranks on the basis of sales records of the product. For example, when the product competition between the specific product and the comparative product is conducted, the control unit 140 may determine the competition ranks in consideration of the sales records including an income of sales, etc. of each product. The control unit 140 may give benefits corresponding to the determined competition rank. Here, the control unit 140 may differentially give the benefits to a seller who sells each product or a buyer who buys each product.

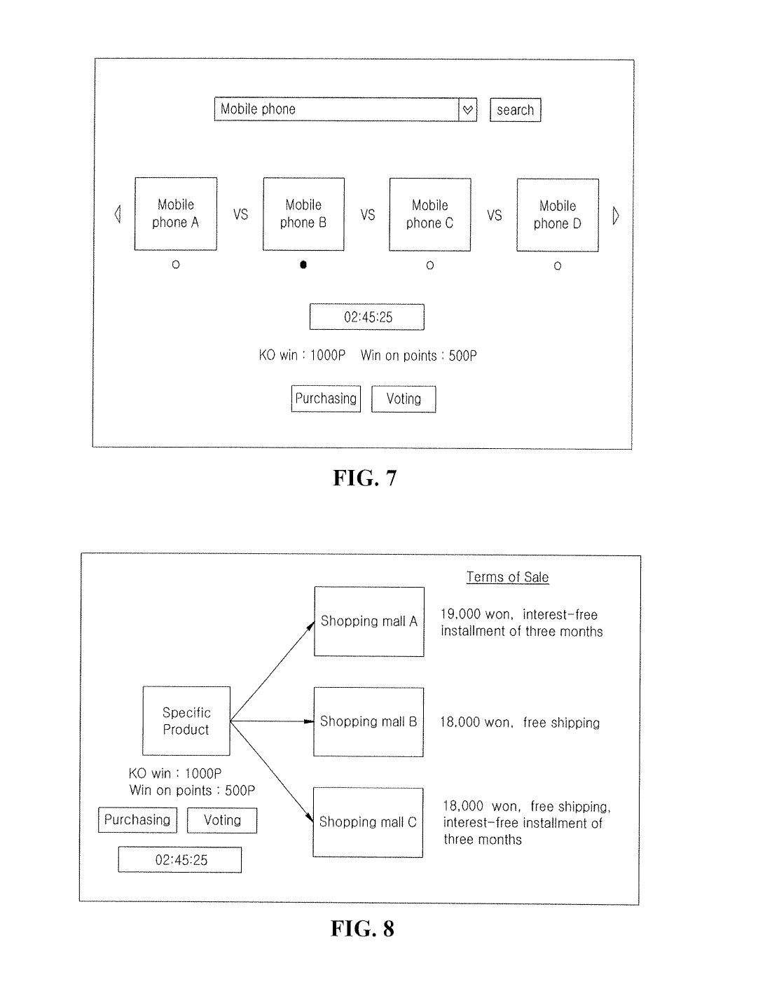

FIG. 7 is a view for explaining a method of conducting a multilateral product competition according to a popular search rank in accordance with an exemplary embodiment of the present invention.

According to an exemplary embodiment of the present invention as shown in FIG. 7, a predetermined number of popular products may be extracted according to a popular search rank, and then a multilateral product competition may be conducted.

For example, when the keyword “mobile phone” is input into a keyword input window provided through a specific site such as a portal site, a plurality of products, mobile phone A, mobile phone B, mobile phone C, mobile phone D, etc., corresponding to the input keyword “mobile phone” may be searched. The mobile phones A, B, C and D may be mobile phones ranked first to fourth popularity ranks among all mobile phones (e.g. 50 mobile phones). In detail, when the keyword “mobile phone” is input through the keyword input window, 50 mobile phones corresponding to the keyword “mobile phone” may be searched. The mobile phones A, B, C and D ranked the first to fourth popularity ranks among the 50 mobile phones may be extracted. Then, a multilateral competition structure may be established between the extracted mobile phones A, B, C and D, and the competition may be conducted. Since the multilateral competition structure may be established for a predetermined time, a competition rank may be determined when the predetermined time has lapsed. The competition rank of the multilateral product competition may be determined in a “win on points” fashion, and benefits corresponding to the determined competition rank may be given. In the multilateral product competition, benefits may be differentially given at a rate of 50% for the product ranked the first popularity rank, 30% for the product ranked the second popularity rank, 15% for the product ranked the third popularity rank, and 5% for the product ranked the fourth popularity rank.

FIG. 8 is a view for explaining a method of conducting a product competition between shopping malls selling the same product in accordance with an exemplary embodiment of the present invention.

According to an exemplary embodiment of the present invention as shown in FIG. 8, a plurality of shopping malls may each further provide different terms of sale in selling the same product.

In detail, there may be a plurality of shopping malls A, B and C selling a specific product. Here, the shopping mall A may present terms of sale of a price of 19,000 won (l7 dollars) and three months of interest-free installments with respect to the specific product. The shopping mall B may present terms of sale of a price of 18,000 won (4 6 dollars) and free shipping with respect to the specific product. The shopping mall C may present terms of sale of a price of 18,000 won, free shipping, and three months of interest-free installments with respect to the specific product. Then, each shopping mall may conduct the product competition on the same product according to the presented terms of sale. The product competition may be realized, for instance, on the basis of a preference test, a popularity test, and so on. As a result of conducting the product competition, the competition ranks of the shopping malls may be determined, and the benefits corresponding to the determined competition rank may be given. Here, the benefits may be given to a seller who sells the product or a buyer who wants to buy the product. For example, the benefits given to the seller may be realized, for instance, on the basis of a fee discount. The benefits given to the buyer may be realized, for instance, on the basis of the accumulation of points, the accumulation of mileage, the provision of a discount coupon, the lottery of a premium, the payment of game money, and so on.

As described above, the method of conducting the product competition between the shopping malls selling the same product in accordance with an exemplary embodiment of the present invention has an advantage in that the buyer can decide on a purchase in an easier, more convenient manner in consideration of the product terms of sale which the shopping malls differently provide for the same product.

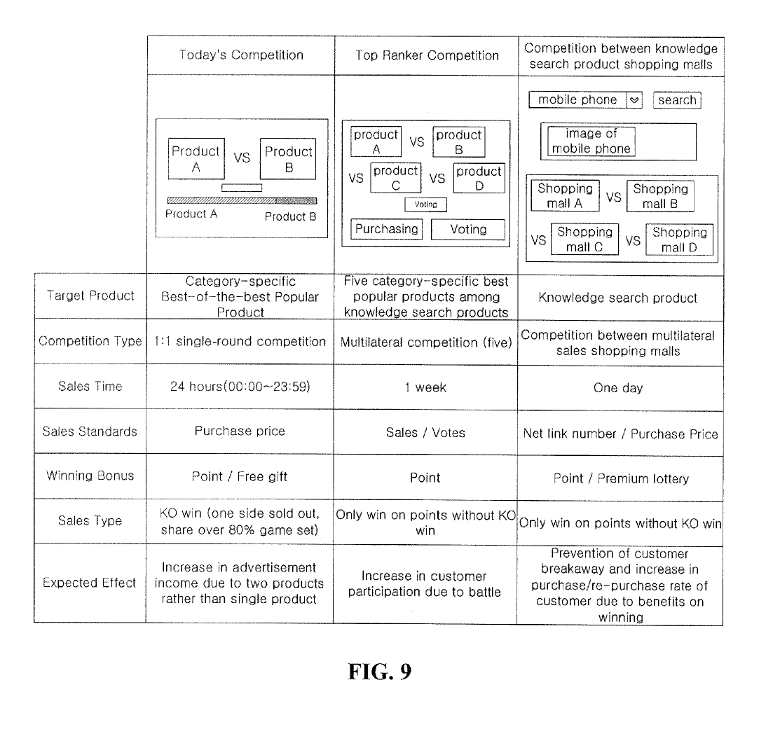

FIG. 9 is a view showing a table for comparing characteristics based on a product competition type in accordance with an exemplary embodiment of the present invention.

According to an exemplary embodiment of the present invention as shown in FIG. 9, product competition types may include a product competition for selecting a best product from daily popular search products, a product competition for selecting a popular search product according to a specific category, a product competition between a plurality of shopping malls selling the same product, etc. such that a competition structure for these product competitions can be established.

First, the product competition for selecting a best product from daily popular search products may include a product competition for selecting a “best of the best” product from popular search products in a day. Thus, the product competition for selecting the best product may be conducted by establishing a 1:1 competition structure. Here, the product competition for selecting a best of best products may be conducted in units of days. Thus, the product competition may be conducted by automatically establishing the competition structure using a daily popular keyword. Then, as a result of conducting the product competition, competition ranks may be determined on the basis of a sum of product purchase money. As a result of conducting the product competition, a winning point may be provided to a winner in a type of points or a free gift. Here, since the product competition is conducted in the 1:1 competition structure, the product competition may be terminated when one product is sold out or cleared off, or is occupied up to 80% or more, and it may be decided that the corresponding product wins the competition as a knockout win.

As described above, the product competition for selecting a best product from daily popular search products has an advantage in that, since it is conducted between at least two products, it can simultaneously advertise the corresponding products to increase an advertisement profit.

Further, the product competition for selecting a popular search product according to a specific category may include selecting five “best of the best” popular products according to the category from the searched products, and establish a multilateral competition structure. Then, a multilateral competition can be conducted between the selected five popular products. Here, the competition may include a multilateral competition type. The competition may be conducted in predetermined units of time such as days, weeks or months. When the competition is terminated with the lapse of the predetermined time, competition ranks between the products may be determined on the basis of sales of the product. Here, a specific vote may be cast to determine the competition rank. The specific vote may include a vote of popularity or preference of the product. When the multilateral competition is conducted, the competition rank may be determined through decision between the products (exclusive of a knockout win). As described above, the product competition for selecting a popular search product according to a specific category has an advantage in that it can increase the participation of customers due to curiosity or interest caused by the product competition.

In addition, the product competition between a plurality of shopping malls selling the same product may include inputting a keyword to search for the product. For example, the keyword may include a keyword for searching for a knowledge search product. Thus, when the keyword is input to search for the product, a plurality of shopping malls setting different terms of sale to sell the same product may be searched. For example, selling prices of specific products of the searched shopping malls may be equal to each other. However, among the plurality of shopping malls, a first shopping mall may further provide free shipping as terms of sale, a second shopping mall may further provide free shipping as well as a 5% discount coupon as terms of sale, and a third shopping mall may provide a 5% discount coupon and three months of interest-free installments as terms of sale. Thus, a buyer may buy a product corresponding to the terms of sale advantageous to him/her with reference to the terms of sale of the first, second and third shopping malls of the plurality of shopping malls. Here, a time for the product competition may be arbitrarily set, and a competition rank of the product may be determined on the basis of a sum of purchase money or the number of links of the product. Further, a winning bonus such as points or the lottery of a premium may be differentially paid according to the determined competition rank.

As described above, the benefits corresponding to the competition rank are given to a buyer who buys the product winning the competition, so that it is possible to prevent the breakaway of customers and increase a purchase rate and a re-purchase rate of the corresponding product.

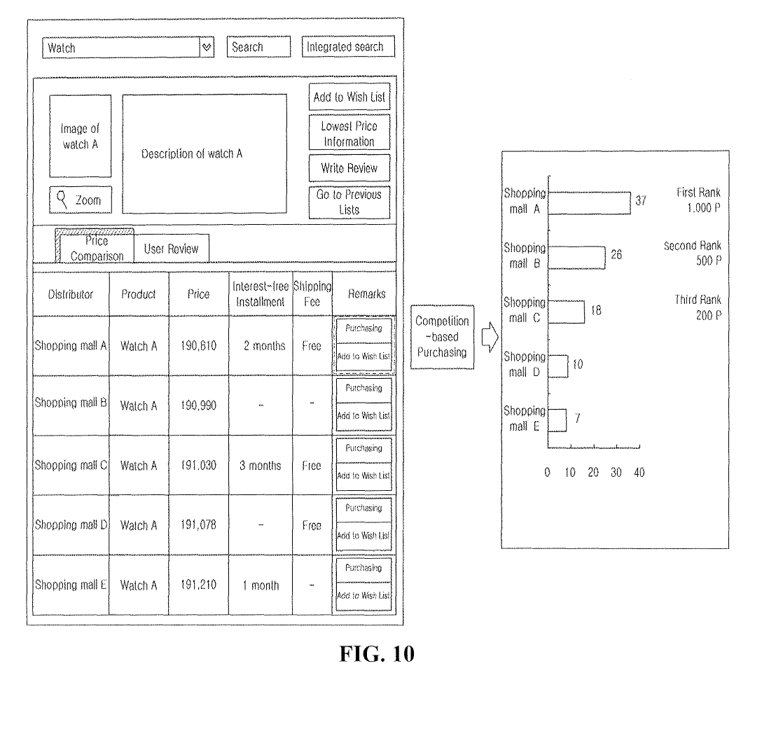

FIG. 10 is a view showing a method of conducting a product competition between shopping malls selling the same product in accordance with an exemplary embodiment of the present invention.

According to an exemplary embodiment of the present invention as shown in FIG. 10, the competition conducted between the shopping malls selling the same product may differentially provide a winning bonus according to a competition rank determined by the competition.

First, when a specific keyword is input through a keyword input window, products corresponding to the input keyword may be searched. In this case, a plurality of shopping malls selling the searched products may be searched as well. The plurality of shopping malls may differently provide terms of sale of a specific product.

First, the keyword “watch” may be input into the keyword input window, and a product search may be requested. Then, the plurality of shopping malls (e.g. shopping malls A, B, C, D and E) selling watches may be searched. Here, each shopping mall may sell the watch A on different terms of sale. In other words, the searched shopping malls may set different selling prices for the same product. Further, the searched shopping malls may sell the specific product to which the terms of sale including the number of months of interest-free installments, shipping expense, etc. of the same product are differently applied. For example, the shopping mall A may provide two months of interest-free installments and a free shipping coupon as the terms of sale of the watch A. The shopping mall B may present only a price as terms of sale of the watch A. The shopping mall C may further provide three months of interest-free installments and a free shipping coupon as the terms of sale of the watch A. The shopping mall D may provide only a free shipping coupon as terms of sale of the watch A. Thus, a buyer may decide on a purchase of the watch A on the condition favorable to him/her with reference to the terms of sale of the shopping malls presented as mentioned above.

As described above, the plurality of shopping malls apply different terms of sale to establish a competition structure for the specific product, so that a buyer can apply the terms of sale favorable to him/her with reference to the established competition structure, and decide on a purchase of the corresponding product from the shopping mall selling the product. When the competition is conducted according to the established competition structure, it is possible to differentially get benefits such as the payment of the bonus so as to correspond to a result of conducting the competition.

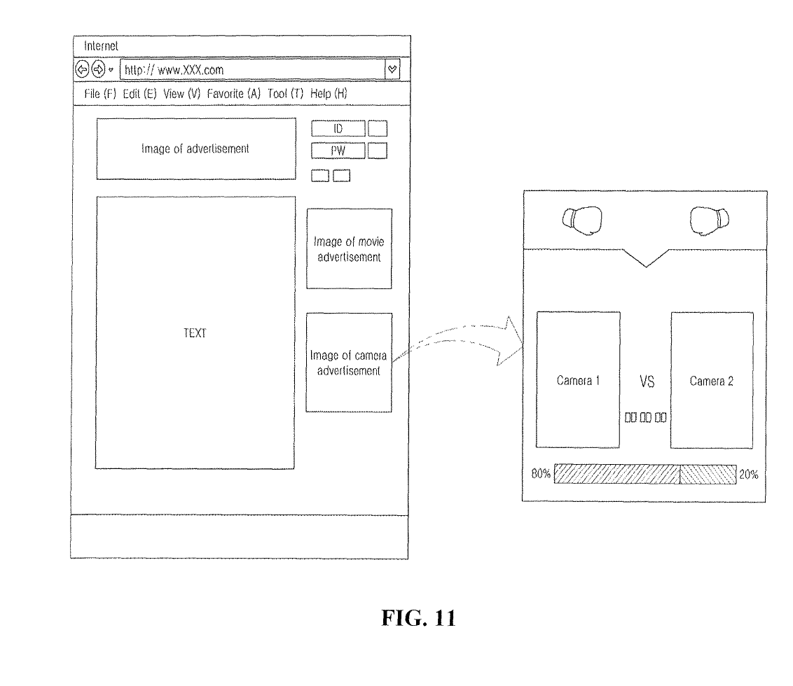

FIG. 11 is a view for explaining a method of moving to a competition space linked when a specific product is selected at a portal site (or in an advertisement space) in accordance with an exemplary embodiment of the present invention.

According to an exemplary embodiment of the present invention as shown in FIG. 11, when a specific product advertised at a portal site is selected, a product competition may be conducted by moving to a product competition space linked to a corresponding advertisement space.

Here, competition ranks between the products may be determined in consideration of the number of clicks for a link from the advertisement space to the competition space or the number of clicks for a link from the competition space to the advertisement space. For example, the competition space may be a specific server conducting the product competition, and the advertisement space may be a specific server in which the advertisement for the product is inserted. Here, the link from the competition space to the advertisement space may be defined as a forward link, while the link from the advertisement space to the competition space may be defined as a backward link. Here, an applied weight may vary according to the click for the forward or backward link.

According to an exemplary embodiment of the present invention as described above, the method of determining competition ranks applies different weights according to whether the link from the competition space to the advertisement space occurs or whether the link from the advertisement space to the competition space occurs, so that it is possible to apply the different weights to determine the competition ranks in a more selective manner.

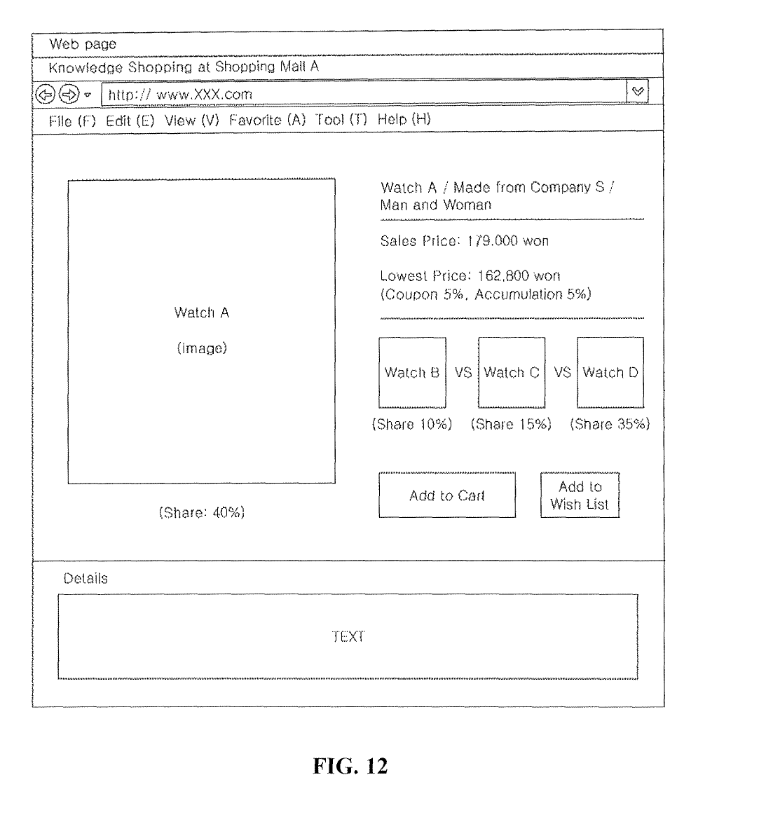

FIG. 12 is a view for explaining a product competition conducting method of displaying a competition situation of comparative products in real time in accordance with an exemplary embodiment of the present invention.

As shown in FIG. 12, the product competition conducting method according to an exemplary embodiment of the present invention may display a product competition situation in real time.

In detail, a buyer may input a keyword through the keyword input window of a specific portal site. Then, the specific portal site may search for a plurality of products corresponding to the input keyword. Here, the plurality of products may include products compared and searched on the basis of the number of clicks, the number of searches, the number of inputs, the result of casting a popularity vote, and so on. Further, the plurality of products may include products compared and searched for a predetermined period on the basis of a specific category.

According to an exemplary embodiment of the present invention as described above, when the plurality of products are compared and searched, a competition structure between the compared and searched products may be established to conduct an automatic product competition. Here, the competition structure may be established within the specific portal site into which the keyword is input without moving to another site for a specific shopping mall.

When a specific product is selected from the plurality of products by a buyer, a web page presenting detailed information about the selected specific product (e.g. watch A) may be provided. Here, a product competition situation of comparative products (e.g. watches B, C and D) may be provided to a predetermined region of the web page in real time. Further, the comparative products may include products other than the specific product in the established competition structure. Further, the comparative products may include products sold at a distributor different from that of the specific product, products having a price and specification similar to those of the specific product, and so on. The web page is provided by the specific portal site, and may display a status bar on a predetermined region thereof such that the buyer can always recognize that the product competition is conducted at the specific portal site (e.g. portal site A).

As described above, in the product competition conducting method according to an exemplary embodiment of the present invention, when the specific product is selected from the plurality of products that are subjected to the product competition, the competition situation of the comparative products other than the selected specific product is displayed in real time in addition to the detailed information about the selected specific product, so that the buyer can check the detailed information about the specific product and simultaneously monitor the overall product competition situation in real time, and thus decide on a purchase in a more reasonable manner.

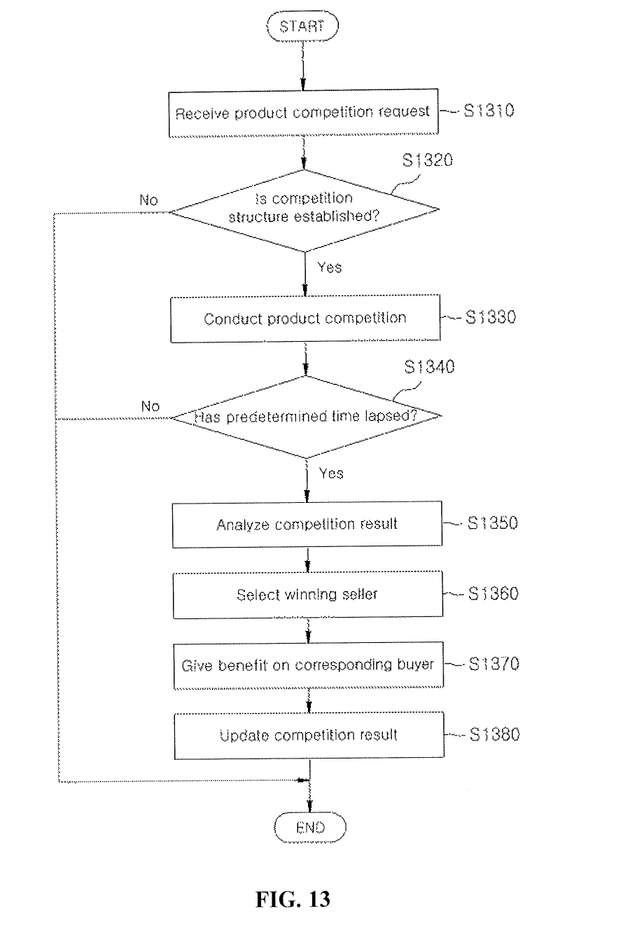

FIG. 13 is a view for explaining a product competition conducting method carried out regardless of a search in accordance with an exemplary embodiment of the present invention.

As shown in FIG. 13, the product competition conducting method according to an exemplary embodiment of the present invention may be carried out regardless of a search at a specific portal site.

First, the product competition conducting system may receive at least one product competition request (S1310). The product competition conducting system may directly receive the product competition requests from at least two sellers including a first seller and a second seller. Further, the product competition requests may be received by the proposal of a recommender including a buyer.

Afterward, a competition structure may be established as received to conduct the product competition (S1320 and S1330). The product competition conducting system may arbitrate a selling method between the sellers, a purchase of the buyer from the seller, deposition of money, shipping, after service, and so on. The product competition conducting system may conduct the product selling competition in a 1:1 competition structure. The product competition conducting system may alter the competition structure into a survival straight win system or a tournament system that consecutively carries out 1:1 rival competitions. The selling competition structure may be selected by a requester when the product selling competition is requested. The selling competition structure may be established by a format that is basically provided by the product competition conducting system. Here, the product competition structure may be established according to a product category such as a brand, a price, a kind, a use, or the like. The product competition conducting system may control the competition situation to be displayed through a display unit in real time. The product competition conducting system may control the product selling situation to be telecast through a specific medium in real time. Here, the specific medium may include a specific Internet site, TV home shopping, IPTV, Internet UCC, or the like.

Afterward, when a predetermined time has lapsed, the product competition conducting system may analyze a result of conducting the product competition (S1340 and S1350). Here, the result of conducting the product competition may be calculated on the basis of a total amount of orders or sales for the products.

Then, the product competition conducting system may select a winning seller according to the analyzed competition result, and give benefits on a buyer who buys the product for sale from the winning seller (S1360 and S1370). Here, the benefits which the product competition conducting system gives to the buyer may include the accumulation of mileage, the accumulation of points, the provision of a discount coupon, and so on. In addition, the product competition conducting system may further provide a winning bonus to the winning seller. The winning bonus may include a selling fee discount, an advertisement priority, and so on. Here, the result of the 1:1 rival competition or the survival straight win competition may be determined as one of a knockout win, a win on points, and a tie. The result of the tournament competition may be determined according to points, a winning rate, and so on.

Afterward, the product competition conducting system may update the result of the competition, the bonus payment situation, etc. to a database (S1380). The result of the competition, the bonus payment situation, etc. updated to the database may be used for a competition history management. Here, the product competition conducting system may select a star seller using the competition history management. The product competition conducting system may expose an advertisement of the star seller to the top.

Meanwhile, according to another exemplary embodiment of the present invention, a multilateral product selling competition structure may be realized. For example, the multilateral product selling competition may be realized by adding third and fourth sellers in addition to the first and second sellers who sell the product using the 1:1 competition structure. When the multilateral product selling competition is conducted for a predetermined time, the product competition conducting system may analyze a result of selling the product to select selling ranks of the plurality of sellers who conduct the multilateral product selling competition. Then, the product competition conducting system may differentially give benefits on the buyers who buy the products for sale from the plurality of sellers so as to correspond to the selected product selling ranks of the plurality of sellers.

Further, the product selling competition structure may be divided according to a category. For example, the product selling competition structure according to a category may be divided according to an idea, a national brand, local connection, price zone, functionality, and so on. The product selling category may be determined according to contents requested by a requester when the product selling competition is requested. Further, the product selling category may be determined by a basic format of the product competition conducting system.

As described above, the product competition conducting system according to an exemplary embodiment of the present invention may display the product competition situation through a display means in real time. Here, the product competition situation may be provided together with items such as an expert rating, specification comparison, and so on. The items may be provided in a shortcut icon type. Thus, when each item provided in the shortcut icon type is clicked, detailed information about the item may be displayed.

In addition, the product competition conducting system according to an exemplary embodiment of the present invention may open the situation of the ongoing product competition only to a specific member. The specific member may include a charged member. The charged member may include a person who pays an annual membership fee or buys game money (i.e. competition money). Thus, the product competition may be conducted so as to be favorable to the specific member subscribed to the charged service.

Meanwhile, the product competition conducting system according to an exemplary embodiment of the present invention may provide an environment in which the specific product may be bet on. In detail, the member may bet the game money on the specific product, and distribute the game money on the basis of a result of betting the game money and a result of conducting the product competition.

For example, it is assumed that the products between which the competition structure is established are products A, B, and C, and that first, second and third members bet 500, 500, and 500 points on the products A, B and C respectively. In this case, when the product A ranks number one in the product competition, the product competition conducting system may provide the game money excluding a predetermined fee from the total bet amount of money (i.e. 1500 points) to the first member. Through this method, it is possible to stimulate interest of the member in shopping to activate electronic commerce.

As described above, the product competition conducting method according to an exemplary embodiment of the present invention may include selling and advertising the product in a competition type, so that it can stimulate interest in shopping and a sense of rivalry to activate electronic commerce.

Further, the product competition conducting method according to an exemplary embodiment of the present invention provides differential benefits according to the member through the membership operation service, so that it can increase a participation rate of the product competition.

In addition, the product competition conducting method according to an exemplary embodiment of the present invention provides the expert rating, the specification comparison, etc. to one web page, so that it can increase convenience of customers so as to enable the buyer to enjoy nonstop shopping.

As described above, in the product competition conducting method and system according to exemplary embodiments of the present invention, the plurality of product distributors (or sellers) sell the same product on different terms of sale, so that the buyer can more easily decide on the purchase with reference to the terms of sale provided by each product distributor when buying the product.

Furthermore, in the product competition conducting method and system according to exemplary embodiments of the present invention, when the specific product sold at the specific shopping mall is selected, the information about and competition situation of the comparative products are displayed in real time in addition to the detailed information about the specific product, so that the buyer can check the detailed information about the specific product and simultaneously monitor the overall product competition situation in real time, and thus decide on a purchase in a more reasonable manner.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of conducting a product competition using a product competition conducting system including an input unit and a control unit having a product distributor extractor, a competition space provider, a competition rank determiner, and a benefit giver, the method comprising:
receiving an input of a specific keyword by the input unit;
extracting at least two product distributors selling a specific product corresponding to the specific keyword by the product distributor extractor;
providing a competition space such that a competition between the extracted at least two product distributors is conducted by the competition space provider;
when a competition structure between the at least two product distributors is established in the provided competition space, determining competition ranks in consideration of at least one selected from sales and a number of product links of the specific product of each product distributor by the competition rank determiner; and
giving benefits corresponding to the determined competition rank by the benefit giver.

2. The method of claim 1, wherein the giving of the benefits includes giving, by the benefit giver, the benefits corresponding to the determined competition rank to a buyer who buys the specific product.

3. The method of claim 1, further comprising, when a buyer is a charged member, providing, by the competition rank determiner, a competition situation between the at least two product distributors to the buyer in real time.

4. A system for conducting a product competition, the system comprising:
an input unit receiving a specific keyword input;
a product distributor extractor extracting at least two product distributors selling a specific product corresponding to the specific keyword;
a competition space provider providing a competition space such that a competition between the extracted at least two product distributors is conducted;
a competition rank determiner determining competition ranks in consideration of at least one selected from sales and a number of product links of the specific product of each product distributor when a competition structure between the at least two product distributors is established in the provided competition space; and
a benefit giver giving benefits corresponding to the determined competition rank.

5. The system of claim 4, wherein the benefit giver gives the benefits corresponding to the determined competition rank to a buyer who buys the specific product.

6. The system of claim 4, wherein the competition rank determiner provides a competition situation between the at least two product distributors to a buyer in real time when the buyer is a charged member.

7. A method of conducting a product competition using a product competition conducting system providing a specific server having an input unit, a control unit, and a display unit, the method comprising:
receiving, by the input unit, an input of a selection signal for a specific product;
controlling, by the control unit, the display unit to output sale information about the selected specific product and link information about at least one shopping mall selling the specific product to the specific server;
when the input unit receives the selection signal for the link information about the specific shopping mall among the link information about the at least one shopping mall, controlling, by the control unit, the display unit to output a screen for the specific shopping mall to the specific server, the screen including information about the specific product and information about a comparative product associated with the specific product;
providing, by the control unit, a competition space through the screen for the specific shopping mall such that a competition between the specific product and the comparative product is conducted at the specific server;
when a competition structure between the specific product and the comparative product is established at the specific server, determining, by the control unit, competition ranks in consideration of sales records of the specific product and the comparative product for a predetermined time; and
giving, by the control unit, benefits corresponding to the competition rank to a buyer who buys one of the specific product and the comparative product at the specific server.

8. The method of claim 7, wherein when the buyer consents to see the comparative product, the control unit controls the display unit to output a competition situation of the comparative product in real time.

9. The method of claim 7, wherein the method is realized within the specific server into which the keyword is input without moving to another server.

10. The method of claim 7, further comprising providing, by the control unit, a competition situation between the at least two product distributors to the buyer in real time when the buyer is a charged member.

11. A system for conducting a product competition using a specific server, the system comprising:
an input unit receiving a selection signal for a specific product and a selection signal for link information about a specific shopping mall among link information about at least one shopping mall;
a control unit controlling sale information about the specific product and the link information about the at least one shopping mall selling the specific product to be output to the specific server; when the input unit receives the selection signal for the link information about the specific shopping mall among the output link information about the at least one shopping mall, controlling a screen for the specific shopping mall to be output to the specific server, the screen including information about the specific product and information about a comparative product associated with the specific product; providing a competition space through the screen for the specific shopping mall such that a competition between the specific product and the comparative product is conducted at the specific server; when a competition structure between the specific product and the comparative product is established at the specific server, determining competition ranks in consideration of sales records of the specific product and the comparative product for a predetermined time; and giving benefits corresponding to the competition rank to a buyer who buys one of the specific product and the comparative product at the specific server; and
a display unit outputting the sale information about the specific product and the link information about the at least one shopping mall selling the specific product, and outputting the screen for the specific shopping mall to the specific server, the screen including the information about the specific product and the information about a comparative product associated with the specific product.

12. The system of claim 11, wherein when the buyer consents to see the comparative product, the control unit controls the display unit to output a competition situation of the comparative product in real time.

13. The system of claim 11, wherein the system is realized within the specific server into which the keyword is input without moving to another server.

14. The system of claim 11, wherein the control unit provides a competition situation between at least two product distributors to the buyer in real time when the buyer is a charged member.
